(19) United States
(12) Patent Application Publication
(10) Pub. No.: US 2009/0078587 A1
(43) Pub. Date: Mar. 26, 2009

(54) Method of Sensor Conditioning for Improving Signal Output Stability for Mixed Gas Measurements

(75) Inventor: Boris Farber, Solon, OH (US)

Correspondence Address: PATENT, COPYRIGHT & TRADEMARK LAW GROUP, 4199 Kinross Lakes Parkway, Suite 275, RICHFIELD, OH, 44286, US

(73) Assignee: BJR Sensors, LLC

(21) Appl. No.: 12/265,201

(22) Filed: Nov. 5, 2008

Related U.S. Application Data
(63) Continuation-in-part of application No. 11/152,971, filed on Jun. 15, 2005.
(60) Provisional application No. 60/580,606, filed on Jun. 18, 2004.
(60) Provisional application No. 60/599,513, filed on Aug. 9, 2004.

(51) Int. Cl. G01N 27/26

(52) U.S. Cl. 205/781; 205/780.5; 205/785.5

(57) ABSTRACT

A method of sensor conditioning is proposed for improving signal output stability and differentiation between responses to different gases such as exhaust from combustion processes. DC (or saw tooth) voltage pulses of opposite polarity and equivalent amplitude are applied between sensor electrodes. Pulses are separated by pauses, when charging power supply is disconnected from the sensor and sensor discharge is recorded. Useful information regarding concentration of analyzed gases can be extracted from two measurement methods:
1. Measuring open circuit voltage decay during the pause immediately following voltage pulse.
2. Measuring the discharge current during pauses following voltage (or current) pulses.

### RELATED APPLICATIONS

The present invention is a Continuation-in-Part of U.S. Ser. No. 11/152,971, filed Jun. 15, 2005, which claimed the benefit of U.S. Provisional Patent No. 60/580,606, filed on Jun. 18, 2004, and U.S. Provisional Patent No. 60/599,513, filed on Aug. 9, 2004. This invention incorporates by reference all the subject matter of the related applications as if it is fully rewritten herein.

### BACKGROUND OF THE INVENTION

1. Field of the Invention

The present invention relates generally to a method of gas sensor conditioning and, more particularly, to conditioning mixed-potential gas sensors for detecting gases common in combustion exhaust.

2. Description of the Related Art

Combustion exhaust gases contain the following major components, namely N₂, O₂, CO, CO₂, H₂O, and NOₓ. In a fuel rich region, exhaust contains excessive concentrations of CO and hydrocarbons (HC). In a fuel lean region, exhaust contains excessive concentration of NOₓ. Close to the stoichiometric point, exhaust contains minimal concentration of these harmful contaminants. (see FIG. 1).

To measure concentration of O₂ in the exhaust gas stream, a zirconia oxygen sensor is typically used. It is generally formed of a zirconia thimble having an inner and outer metal coating, usually platinum, to form an electrode (See FIG. 2). These electrodes are then used to measure the differential oxygen concentration between the measured gas on the outside of the thimble, and a reference gas, usually atmospheric air, on the inside of the thimble. By measuring the voltage between two electrodes, the differential oxygen concentration can be calculated. Several electrochemical reactions are taking place on the electrode surface in the vicinity of triple phase boundary lines (TPBL—a line separating the Pt electrode, the analyzed gas and the Zirconia substrate):

O₂+4e⁻ [symbol] 2O²⁻ (1)

CO+O²⁻ [symbol] CO₂+2e⁻ (2)

2NO+4e⁻ [symbol] N₂+2O²⁻ (3).

Reaction (1) takes place on both electrodes (measuring electrode −1 and reference electrode −3, see FIG. 2). Reactions (2) and (3) take place only on the measuring electrode. At elevated temperatures (>600° C.), rates of reactions (2) and (3) are negligibly small in comparison with reaction (1), which allows utilization of zirconia oxygen sensor for direct measurements of O₂. Sensor response in this range is described by the Nemst Equation:

EMF=RT/4F*Ln(Pₐᵢᵣ/P_{gas}) (4)

where R=8.31 joule/(mole*K) is the perfect gas molar constant, T is the absolute temperature, F=96485.33 is the Faraday constant, Pₐᵢᵣ is the partial pressure of oxygen on reference side of the sensor, and P_{gas} is the oxygen partial pressure on the measurement side.

At lower temperatures (<500° C.), rates of reactions (2) and (3) become compatible with reaction (1), allowing a possibility that zirconia sensor be used for measurements of other gases constituting combustion exhaust. Sensor response can be no longer described by the Nemst equation, typically generated sensor output is significantly higher than EMF predicted by equation (4). Since several reactions are taking place simultaneously on measurement electrode, sensor response in this range is called mixed potential.

In the range of mixed potential, oxidation reaction (2) is consuming oxygen ions in the vicinity of the active reaction sites (TPBL) and will increase the sensor output, thus the presence of an increased concentration of carbon monoxide will increase sensor output. On the other hand, reduction reaction (3) will increase the oxygen ions concentration in the vicinity of TPBL; thus, the presence of increased concentrations of nitrogen monoxide will decrease the sensor output. In the range of mixed potential, a zirconia sensor has very weak response to variations of oxygen partial pressure.

Several types of mixed-potential gas sensors have been developed for combustion control and environmental monitoring processes. FIG. 3 and FIG. 4 show examples of possible sensor configurations used for mixed potential measurements in addition to the configuration shown in FIG. 2.

In FIGS. 3 and 4, both measurement electrodes are exposed to the analyzed gas. A mixed potential signal is generated due to the different catalytic activity of these measurement electrodes. These sensors clearly demonstrated strong response to the presence of carbon monoxide and nitrogen oxide; however, their lack of stability, repeatability and selectivity did not allow the development of a viable commercial sensor. (See U.S. Pat. No. 6,605,202 B1).

U.S. Pat. No. 5,554,269 to Joseph, et al., teaches a Differential Pulse Voltametry (“DPV”) method to improve selectivity and sensibility of the zirconia oxygen sensor. The DPV method is comprised of superimposing biased increasing voltage applied between sensor electrodes with pulsed voltage and then measuring resulting current at the moment of abrupt voltage changes. The generated current is related to concentration of NOₓ present in the analyzed gas. The drawback of DPV is related to the fact that the generated current is inversely proportional to the sensor electrode resistance. Electrode resistance usually increases due to sensor degradation, additionally, DPV involves biasing sensor electrodes with DC voltage, which will result in electrode polarization and will increase sensor resistance. Variation of electrode resistance will require frequent recalibrations to maintain reasonable accuracy.

U.S. Pat. No. 4,384,935 to De Jong teaches a sensing mechanism based on an electrochemical pumping current method under equilibrium ideal conditions governed by the forgoing Nernst equation (4), which is principally different from the mixed potential sensor response conditions. Positive and negative pulses are used to pump in and out gas in the sealed chamber. Variations in reference gas pressure in equation (4) will change the sensor output until it reaches a predetermined value, and then the chamber is refilled by applying current pulses of opposite polarity. Analyzed gas concentration is related to the overall transferred charge or time required for filling and/or refilling processes. In De Jong, current is always measured under applied pumping or filling currents. Furthermore, there are no pauses or measurements between the pulses of opposite polarity. De Jong's pulsing serves to pump gas and to provide for the basic sensor operation. The stated purpose of this design is not for electrode conditioning.

U.S. Pat. No. 6,200,443 to Shen, et al., teaches a diagnostic device based on measuring capacitance of a sensor by charging and discharging a capacitor associated with the sensor. Pulses of single polarity are applied. The sensor discharge curve is an indication of the sensor capacitance value and proper sensor operation conditions. There is no indication the discharge slope is related to the concentration of the analyzed gas. Therefore, Shen does not use pulses for gas measurements; rather, Shen uses single polarity voltage pulses for diagnostics of the sensor operational conditions. An oxygen sensor in a mixed potential mode will not properly operate under voltage pulses of single polarity. This would lead to charge accumulation and the sensor would be precluded from responding to the analyzed gas.

U.S. Pat. No. 4,500,391 to Schmidt discloses an improved method of differential pulse voltammetry with a constant bias superimposed on single polarity DC pulses between two electrodes. Current is measured just before application of the DC pulse and just before termination of the DC pulse. The difference in current values is related to the analyzed gas concentration. Schmidt does not suggest measurements of transient voltage characteristics during the discharge of the sensor and all the measurements are conducted under applied DC bias.

Shen and Scmidt use pulses of single polarity. An oxygen sensor in a mixed potential mode will not properly operate under pulses of single polarity. This would lead to charge accumulation and the sensor will be precluded from responding to the analyzed gas. In the present invention, DC pulses of positive and negative polarity are separated by applied pauses. Transient characteristics of the sensor output discharge are measured during the pauses.

### SUMMARY OF THE INVENTION

It is an object of the present invention to improve the speed of sensor response, to eliminate sensor output drift, and to improve selectivity to the analyzed gas.

Electrode activation treatment, by means of applying DC pulses of positive and negative polarity, allows continuous reactivation of the reaction sites on a sensing electrode by providing a supply of oxygen ions. Since sensor output is perturbed by DC pulses, traditional methods of measuring sensor output are not applicable. The present invention provides a new method of sensor output measurements comprising at least a step of separating DC pulses by pauses when discharge characteristics of the sensor output can be measured, approximated by the straight line in the V˜log(t) coordinates, and an extrapolated voltage value at a given elapsed time during the pause can be calculated Vᵣ.

These calculated values show strong response to analyzed gases (NO, CO etc.) with improved speed of response, reduced drift, and improved selectivity.

The present method was applied to a Lambda sensor (automotive exhaust sensor), a commercial zirconia oxygen sensor for industrial boilers, and a zirconia based mixed potential sensor equipped with gold composite electrodes. The present invention significantly improves those sensors' performance.

This invention is based on a new experimental findings in a mixed potential sensor, s.a., e.g., a zirconia-based oxygen sensor at low temperatures, wherein sensor discharge characteristics (slope and constant of a discharge voltage versus Log(time) curves) is directly related to the concentration of redox gases present in the analyzed gas sample. This method can be applied to any gas sensor with at least two electrodes; however, in its preferred embodiment, it is particularly suited for mixed potential sensors.

The present invention measures the discharge slope of the sensor voltage during pauses following each sequential positive/negative pulses. The present method improves signal stability, increases sensitivity, and accelerates response verses those of traditional EMF measurement techniques when no perturbation pulses are applied.

The present invention suggests a new method for detecting concentrations of oxidizable (carbon monoxide, unburned hydrocarbons, etc) and reducible (nitrogen monoxide, etc) gases such as those present in a combustion exhaust stream. The method is based on subjecting the sensor electrodes to a conditioning treatment. DC (or saw tooth) voltage pulses of opposite polarity and equivalent amplitude are applied between sensor electrodes. Pulses are separated by the pauses when the charging power supply is disconnected from the sensor and the open circuit sensor discharge is recorded such as with a Data Acquisition System (DAQ). Useful information regarding the concentration of analyzed gases can be extracted by measuring the voltage decay during the pause immediately following the voltage pulse.

The kinetics of sensor discharge is related to the net concentration of reducible/oxidizible gases, which would control the concentration of O²⁻ ions in the vicinity of TPBLs according to reactions 1-3).

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a schematic representation of combustion process exhaust;

FIG. 2 is a schematic of a Zirconia Oxygen sensor;

FIG. 3 is schematic diagram of a type 1 mixed potential sensor with two electrodes exposed to analyzed gas;

FIG. 4 is a schematic diagram of a type 2 mixed potential sensor with two electrodes exposed to analyzed gas and the reference electrode exposed to air;

FIG. 5 is a schematic representation of sensor conditioning in accordance with present invention;

FIG. 6 is diagram of a discharge of the sensor with both electrodes exposed to air;

FIG. 7 is a diagram of the discharge of the sensor with measurement electrode being exposed to combustion exhaust;

FIG. 8 shows the response of an automotive lambda sensor to pulses of NO (0-1000 ppm) at 3% O₂ without conditioning treatment according to a known procedure;

FIG. 9 shows output from an automotive lambda sensor while subjected to conditioning treatment and explains the data processing algorithm with the proposed method according to preferred embodiment;

FIG. 10 shows response of an automotive lambda sensor to pulses of NO while subjected to conditioning treatment with proposed method according to preferred embodiment:

FIG. 11 shows response of an automotive lambda sensor to step changes of NO while subjected to conditioning treatment with the proposed method according to preferred embodiment;

FIG. 12 shows a calibration curve relating sensor output with the applied NO ppm concentration

FIG. 13 shows measured NO ppm concentrations during step changes of NO with proposed method according to preferred embodiment;

FIG. 14 shows measured NO ppm concentration in response to 0-1000 ppm NO pulses with proposed method according to preferred embodiment;

FIG. 15 shows interference with pulses of CO (0-1000 ppm) and NO=0 ppm;

FIG. 16 shows interference between NO (250 ppm) and CO (250 ppm)@3% O2;

FIG. 17 shows interference with changes in oxygen concentration in the range 0.5-10% at NO=0 ppm;

FIG. 18 shows interference with changes in oxygen concentration in the range 0.5-10% at NO=250 ppm.

FIG. 19 shows interference between NO (250 ppm) and NO₂ (75 ppm)@3% O2;

FIG. 20 shows response of a lambda sensor to step changes of NO under different test conditions

FIG. 21 shows comparison in measured NO concentration in the preferred embodiment of the current invention and a bench top NO analyzer.

FIG. 22 shows NO measurements with a commercial zirconia oxygen sensor for boiler combustion control while subjected to conditioning treatment with the proposed method according to preferred embodiment.

FIG. 23 shows response of an automotive lambda sensor to step changes of CO while subjected to conditioning treatment with the proposed method according to preferred embodiment

FIG. 24 shows response of a commercial zirconia oxygen sensor for boiler combustion control while subjected to conditioning treatment with the proposed method according to preferred embodiment to step changes of CO while subjected to conditioning treatment with the proposed method according to preferred embodiment.

FIG. 25 shows response of a mixed potential zirconia based sensor equipped with Pt and Au-20 wt % Ga₂O₃ sensing electrodes to step changes of CO 0-1000 ppm at 600° C. and 5% O₂ as known in the prior art without conditioning treatment.

FIG. 26 shows response of a mixed potential zirconia based sensor equipped with Pt and Au-20 wt % Ga₂O₃ sensing electrodes to step changes of CO 0-1000 ppm at 600° C. and 5% O₂ under conditioning treatment in the preferred embodiment of the current invention.

### DESCRIPTION OF THE PREFERRED EMBODIMENTS

The best mode for carrying out the invention is presented in terms of its preferred embodiment as applied to different types of known zirconia oxygen sensors with Pt electrodes exhibiting a mixed potential response at low temperatures (T≦500° C. including but not limited to: automotive Lambda sensors, potentiometric zirconia oxygen sensors for industrial boiler control, potentiometric oxygen sensors with Pt and composite gold electrodes operating in a mixed potential mode.

In order to describe the complete relationship of the improved invention to the prior art, it is essential that some description be given to the manner and to the practice of the functional utility of a conventional mixed potential sensors. Mixed potential sensors are a class of sensors defined by the gas detection principle rather than by the method of measurement of the electromotive force generated by the sensor. If two electrochemical reactions take place simultaneously on an electrode, the electrode potential is determined by the rates of the electrochemical reactions involved; this potential is called mixed-potential. The concept of mixed-potential for stabilized zirconia-based sensors was first introduced to explain non-ideal behavior of an oxygen sensor in the mixed gases of air and fuel (oxidizable gases) by Fleming (see Fleming, W. (1977). “Physical Principles Governing Non-ideal Behavior of the Zirconia Oxygen Sensor.” JOURNAL OF THE ELECTROCHEMICAL SOCIETY 124(1): 21-28. The justification for classification of oxygen sensors as a mixed potential at low temperatures <550° C. is based on a fact that sensor response (“EMF”) can no longer be described by the Nernst equation (4):

Electrochemical reactions taking place on the electrodes in the presence of O₂ and NO can be described as the following equations:

NO+O²⁻→NO₂+2e⁻ and ½O²+2e⁻→O²⁻

For each mole of NO, only ½ mole O₂ is required by the reaction under equilibrium conditions. To describe sensor response at the test conditions of T=500° C., O₂=3%, Pₐᵢᵣ=20.95%, and P_{gas}=3% in the presence of 1000 ppm NO, equilibrium O₂ concentration will change from 3% to 2.95%. According to equation (4), EMF generated by the sensor will change from 32 mV to 33 mV (˜1 mV).

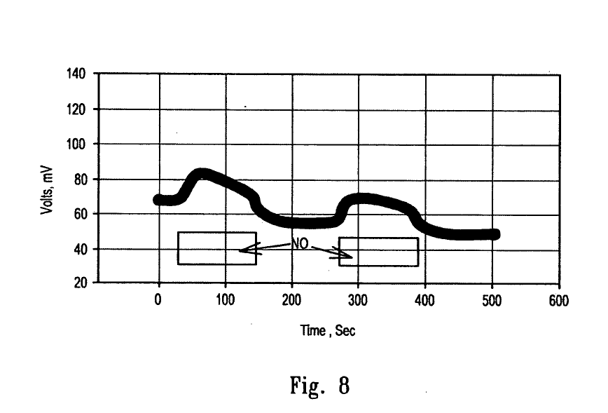

Results shown in FIG. 8 below indicate that sensor output changes by ˜15 mV as a response to 1000 ppm NO. This sensor response is more than an order of magnitude higher than expected under equilibrium ideal conditions. This phenomenon (much higher than expected sensor output) is a reason to define sensor response as a mixed potential response. Mixed potential response of zirconia based oxygen sensors at low temperatures are reported in prior art.

Oxygen sensors at low temperatures exhibit mixed potential response due to the inability of the Pt electrode to catalyze thermodynamic equilibrium between the trace gases and oxygen. The gases such as NOx CO react more quickly with oxide ions or vacancies than oxygen gas and thus influence the electrode potential. At higher temperatures, the catalytic reaction rates of oxygen with the trace gases are much higher, and sensor response can be described by an equilibrium Nemst equation.

Due to low oxygen diffusivity, sensor response is sluggish and products of electrochemical reactions accumulate at the reaction sites leading to sensor output drift. Despite the fact that several types of mixed-potential gas sensors have been developed for combustion control and environmental monitoring processes, their lack of stability, repeatability and selectivity did not allow the development of a viable commercial sensor. (See U.S. Pat. No. 6,605,202 B1).

### DETAILED DESCRIPTION OF THE PREFERRED EMBODIMENTS

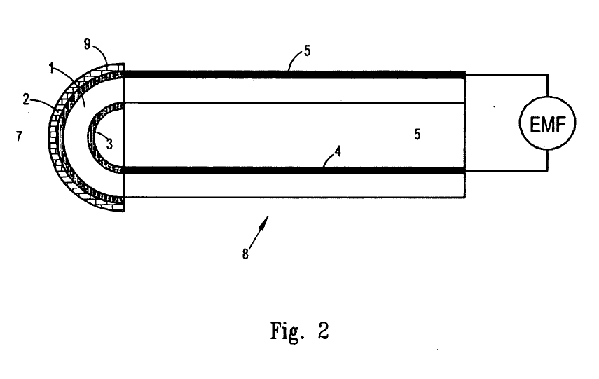

1. Traditional zirconia oxygen sensor (8) as shown in FIG. 2.

The sensor is generally formed of a zirconia thimble (1), having an inner platinum coating (3) and an outer platinum coating (2) to form a reference and measuring electrodes. The reference electrode is usually exposed to ambient air (5) and the measuring electrode is exposed to analyzed gas (7). Electromotive Force (EMF) measured between measuring and reference electrodes is used to obtain partial oxygen pressure in the analyzed gas. An automotive lambda sensor also contains a porous ceramic coating deposited on top of the measuring electrode as a protection against poisoning components in the combustion exhaust.

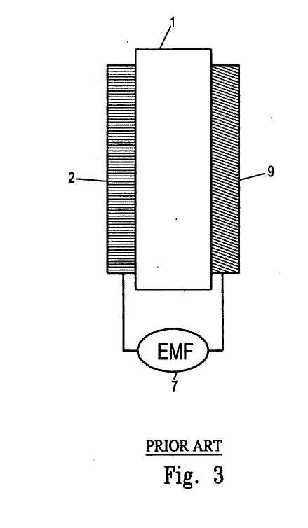

2. Mixed potential sensor (type 1) as shown in FIG. 3. Both electrodes of the sensor (2 and 9) are exposed to analyzed gas.

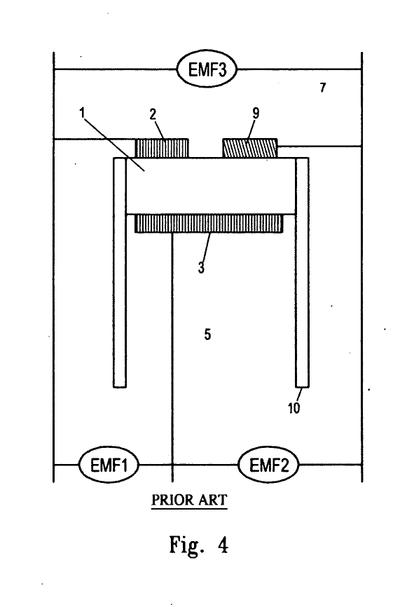

3. Mixed potential sensor (type 2) as shown in FIG. 4. Sensor has two measuring electrodes (2 and 9) exposed to the analyzed gas and a reference electrode (3) usually exposed to air.

4. Lambda sensors—both thimble type and planar multilayer design.

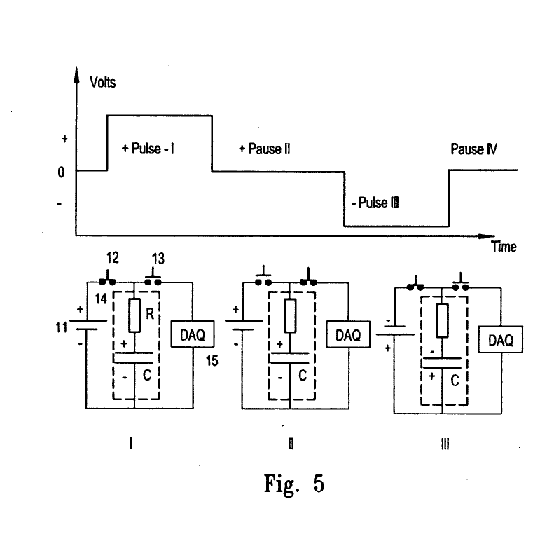

A schematic diagram of a proposed conditioning treatment is shown in FIG. 5. Sensor (14) is represented by resistor R and capacitor C connected in series. During a positive Pulse (I) the sensor is connected with a power supply (11) by closing the switch (12) and opening switch (13). The measuring sensor electrode (exposed to analyzed gas) is charged positively according to the polarity of power supply. During the pause (II), switch 12 is open and switch 13 is closed. Sensor electrodes are disconnected from the power supply and an open circuit sensor discharge is recorded with a Data Acquisition System (DAQ). At the end of the pause, sensor electrodes are disconnected from DAQ and connected to the power supply, but with reverse polarity (III). The measuring sensor electrode is charged negatively. At the end of the negative pulse, sensor electrodes are again disconnected from the power supply and reconnected with DAQ by opening switch 12 and closing switch 13 and sensor discharge is recoded with DAQ. At the end of the pause, sensor electrodes are connected again with power supply with direct polarity, and the process will repeat itself.

In another aspect of the present invention, DAQ can be permanently connected to the analyzed sensor and only switch 12 is used to connect and disconnect sensor electrodes from the power supply.

For a traditional oxygen sensor, Voltage is applied between the reference and measuring electrodes (2 and 3, see FIG. 2). For a mixed potential sensor of type 1,—voltage is applied between two measuring electrodes (2 and 9 see FIG. 3). For a mixed potential sensor of type 2,—voltage can be applied either between two measurement electrodes (2 and 9) or between each of the measurement and reference electrode (2 and 3, or 9 and 3 see FIG. 4).

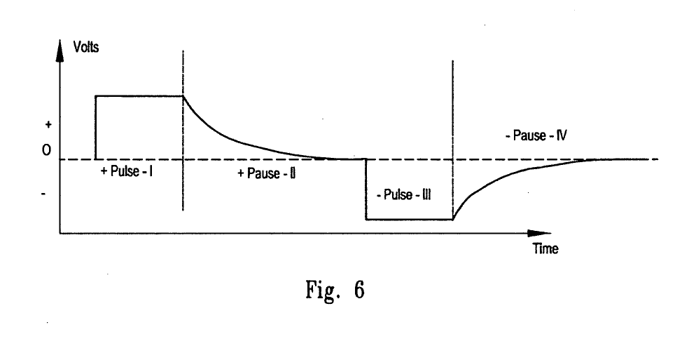

When both sensor electrodes are exposed to air, the sensor generates zero output voltage. In this case, a sensor charged negatively/or positively will completely discharge after negative/or positive pulses, provided that the pause between pulses is long enough (See FIG. 6).

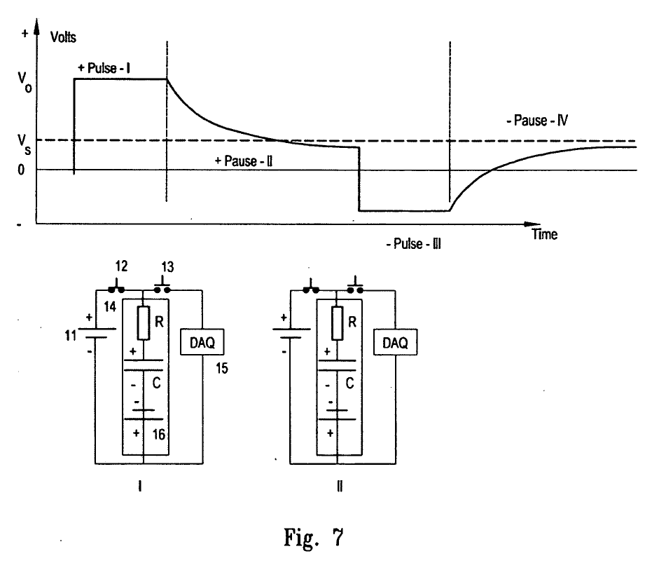

If the measurement electrode is exposed to combustion exhaust, the sensor will generate a voltage output (Vₛ, see FIG. 7) (either according to Nernst equation (4), or according to mixed potential response). Superimposition of positive/or negative pulses will result in a discharge kinetic as shown in FIG. 7. Sensor output (Vₛ) can be extracted from discharge kinetics in several ways:

1) Pause duration between pulses is long enough and sensor can be completely discharged to the level of Vₛ.
2) Kinetics of sensor discharge can be described by an equation relating sensor discharge voltage as a function of elapsed time which will allow faster measurements by reducing pause durations.

### 1. Example 1 Nitrogen Oxide (NO) Measurements with an Automotive Lambda Sensor

According to one example of the preferred embodiment of the present invention a concentration of NO was measured by using a traditional zirconia oxygen sensor and the proposed conditioning treatment. An automotive lambda sensor (capable of accurate measurements of oxygen concentrations in a wide range 0.5-10%) was placed inside a heated furnace with the temperature of ˜510° C. The sensor was equipped with an internal heater and the heater voltage was set at V=10 Volts. The sensor measurement electrode was exposed to different mixtures of N₂; O₂; NO; NO₂, and CO gases, simulating conditions in the combustion process exhaust.

To demonstrate advantages of the proposed method, we first exposed sensor to pulse changes in the concentration of NO (0-1000 ppm) at O₂ concentration of 3% (balance N₂). FIG. 8 shows the lambda sensor mV response to applied NO. Sensor response is rather weak (<15 mV) and shows significant drift of the base line. This behavior is typical for traditional zirconia oxygen sensors at relatively low operating temperatures. (See “Progress in mixed—potential type devices based on solid electrolyte for sensing redox gases” by N. Miura, G. Lu, N. Yamazoe, Solid State Ionics v. 136-137, pp 533-542, 2000″)

This type of sensor response cannot be directly utilized to measure NO concentration due to significant drift of the output.

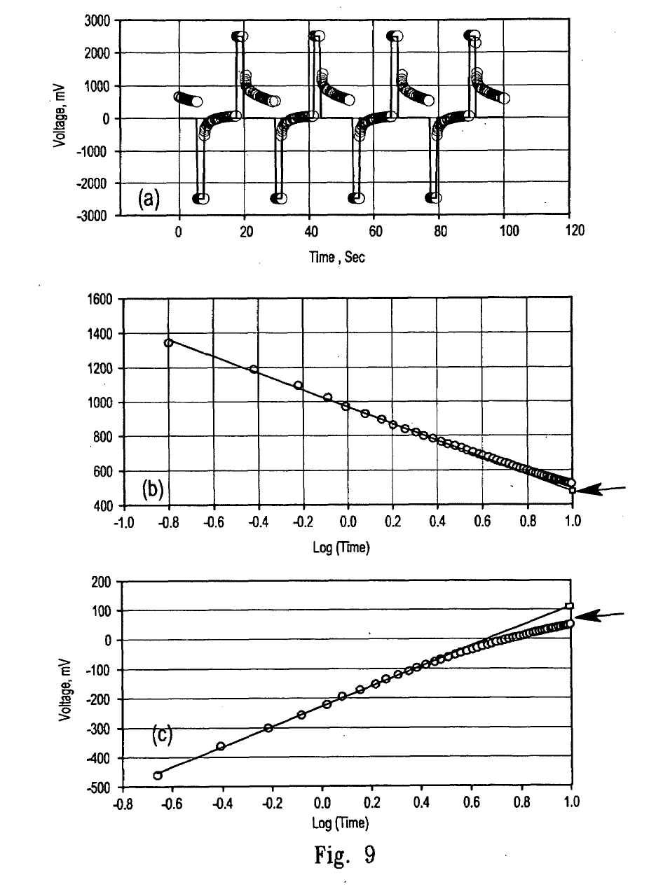

FIG. 9(a) shows sensor output signal while subjected to conditioning treatment in accordance with the present invention. The conditioning treatment involved DC pulses with the amplitude of +1-2.5 Volts and with the duration of 2 sec. Pulses were separated by pauses (with the duration of 10 sec), when the sensor electrodes were disconnected from the power supply. Solid line in FIG. 9(a) shows applied voltage and filled circles show voltages measured with DAQ. Sensor discharge during pauses following positive and negative voltage pulses was approximated by equation

V=Vo+S*Log(t) (5)

Where Vₒ is a constant and S is a slope

Results of the curve fitting procedure are shown in FIGS. 9(b) and 9(c). Initial parts of the discharge curves can be approximated by a straight line in semi-logarithmic coordinates. The fitting line was extrapolated to pause duration t=10 sec to determine the sensor response voltage Vᵣ=Vₒ+S*Log(10). Squares and arrows FIGS. 9(b) and 9(c) show the resulting extrapolated voltages. These voltages were subsequently used to measure sensor response to analyzed gases under conditioning treatment according to a preferred embodiment of the present invention.

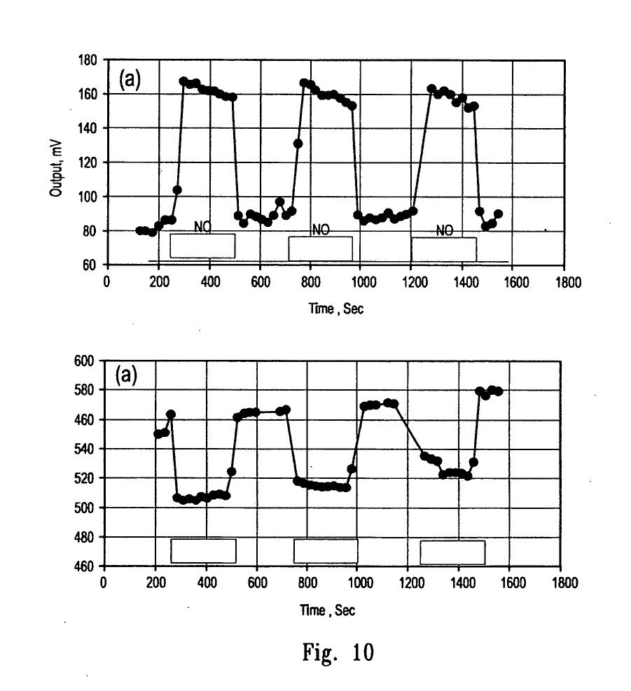

FIG. 10 shows response of the EGO sensor to pulse changes in the concentration of NO by using the sensor conditioning treatment measured in the same test set up as shown in FIG. 8. The conditioning treatment resulted in significant amplification of the sensor response to the analyzed gas (NO) from 15 to ˜80 mV and significantly reduced drift of the sensor base line signal (at NO=0 ppm). The achieved improvements are the most pronounced for sensor response measured during the pause following positive voltage pulses. Activation of the sensor measurement electrodes with positive Voltage pulses resulted in an increase of the sensor output in response to applied NO, while activation of the sensor measurement electrodes with negative Voltage pulses resulted in a decrease of the sensor output in response to applied NO (see FIGS. 10 (a) and 10 (b).

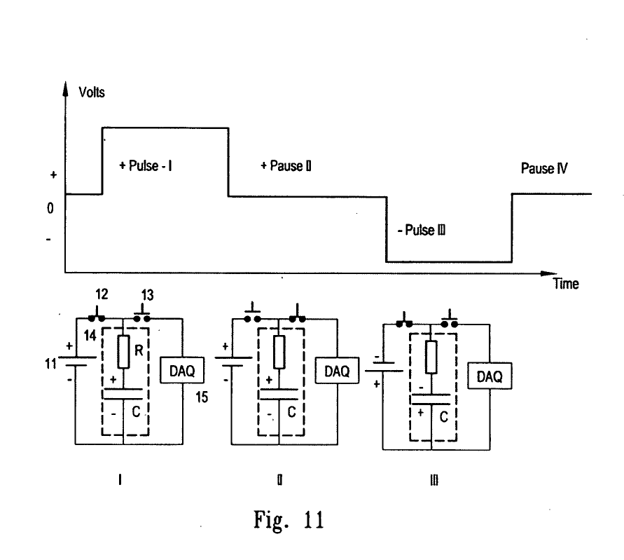

FIG. 11 shows sensor response to step changes of NO (0; 50; 100; 200; 500; 1000; 500; 200; 100; 50; 0 ppm) while subjected to the conditioning treatment. Sensor response is strong and shows little hysteresis.

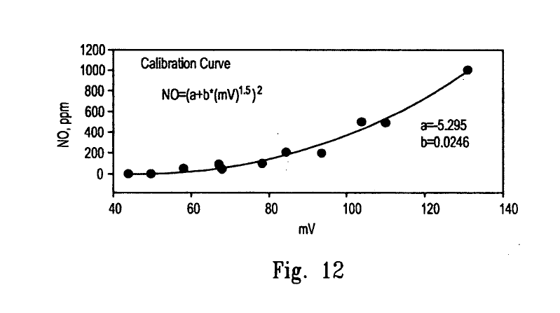

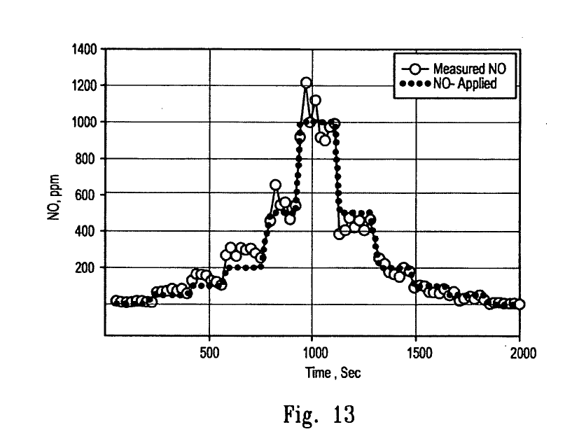

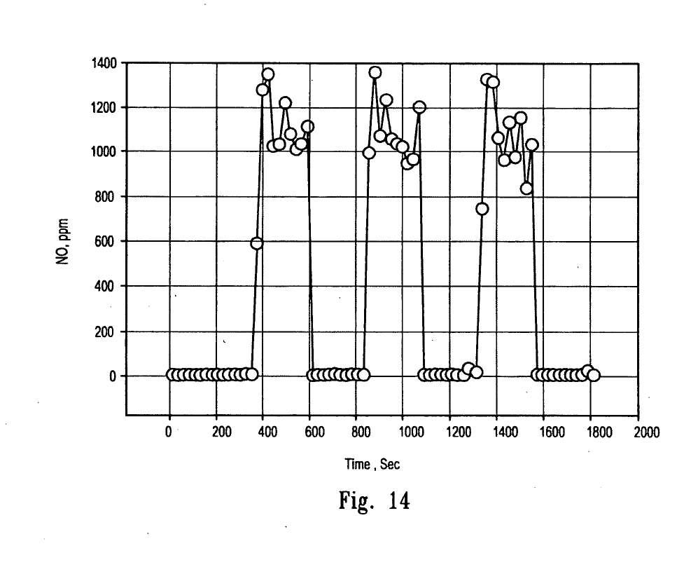

Data shown in FIG. 11(a) were used to establish a calibration curve relating the concentration of NO with the sensor response, which is shown in FIG. 12. This calibration curve was used to directly measure NO concentration in the analyzed gas under conditions of step changes in NO concentrations (0; 50; 100; 200; 500; 1000; 500; 200; 100; 50; 0 ppm) (see FIG. 13) or during pulse changes in NO (0-1000 ppm) (see FIG. 14). In both cases, the sensor conditioning treatment resulted in stable and repeatable sensor output in response to the analyzed gas.

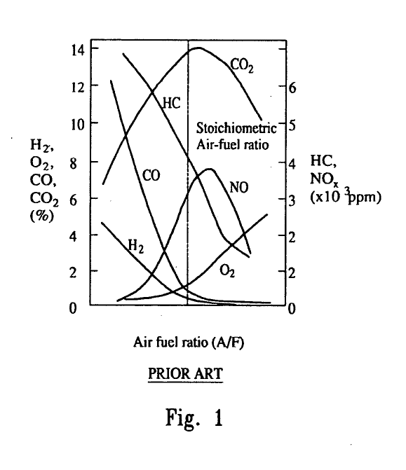

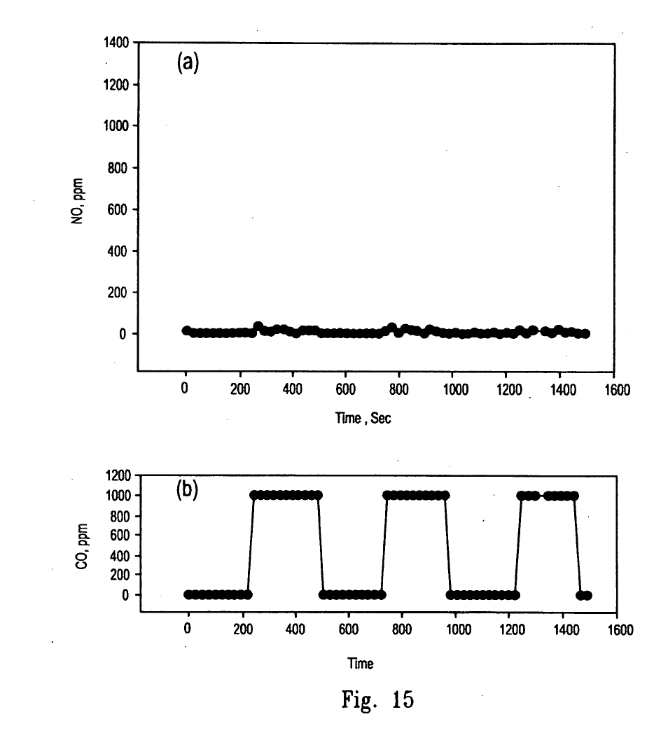

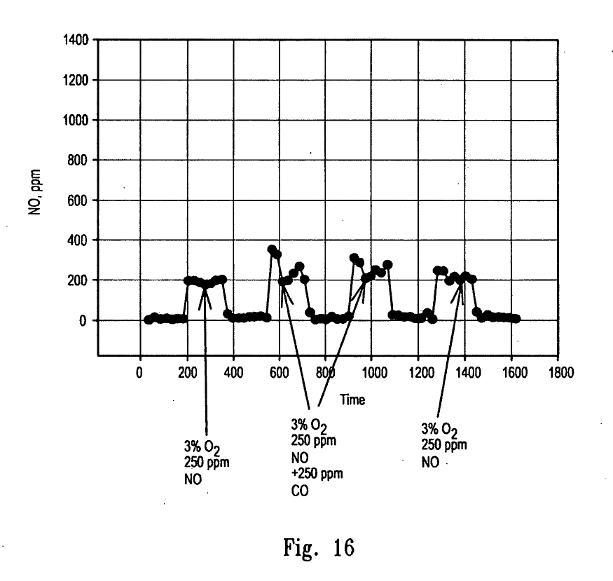

As seen in FIG. 1 combustion exhaust contains mixed gases O₂, NO, CO etc. Cross-interference of sensor output is an important factor in providing reliable measurements of the individual gases in the mixture. We verified interference of the lambda sensor response to CO and O₂ variations while subjecting sensor to conditioning treatment. Desirable range of NO detection for a combustion process is 0-1000 ppm. Provided data will show interference with other gases at low (NO=0 ppm) and mid range (NO=250 ppm) NO concentrations. FIG. 15 shows that sensor response to 1000 ppm CO (at NO=0 ppm) is not exceeding 30 ppm NO. Interference of 250 ppm CO at 250 ppm NO is 49+/−45 ppm NO (See FIG. 16)

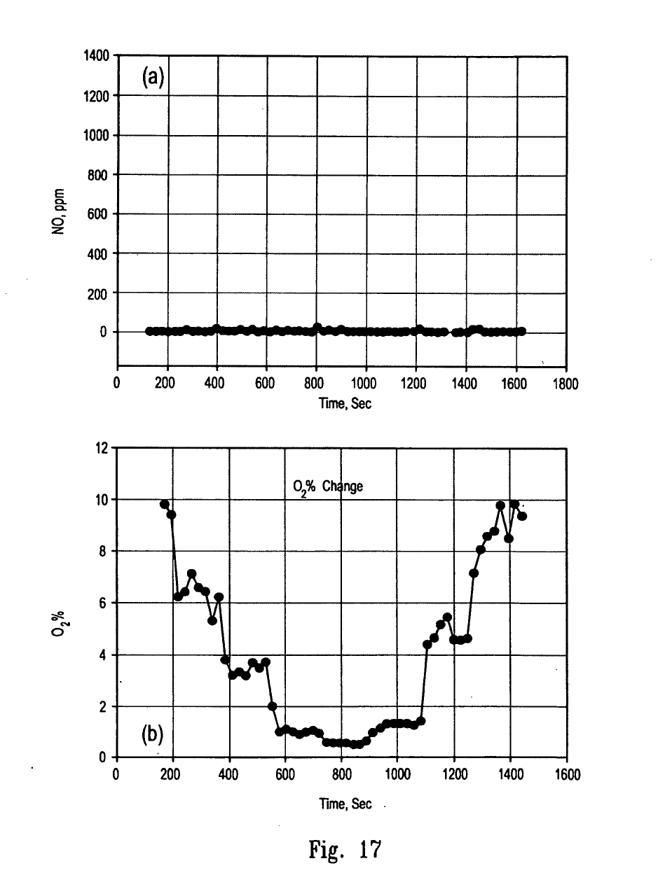

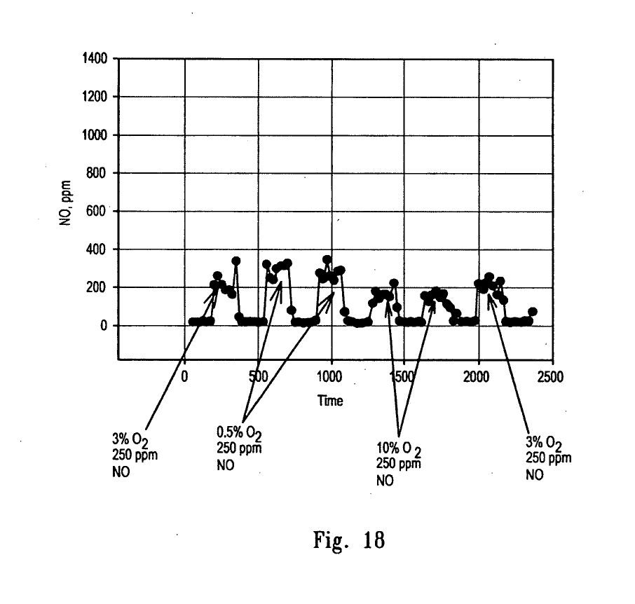

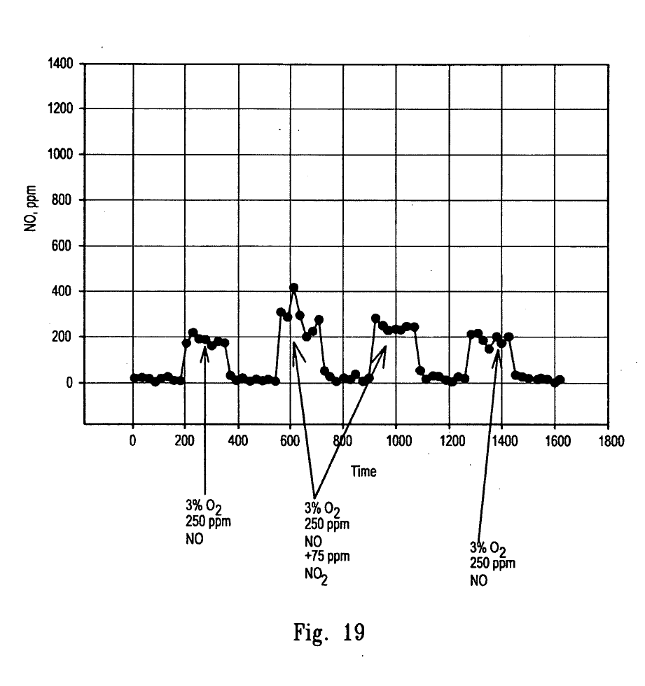

Interference of O₂ in the range of 0.5-10% is not exceeding 25 ppm NO (at NO=0 ppm) (See FIG. 17) and it is 61+/−25 ppm NO (at NO=250 ppm) (see FIG. 18) FIG. 19 shows effect of the addition of 75 ppm NO₂ to 250 ppm NO in the gas mix. The resulting shift in the sensor output is 78+/−30 ppm, providing direct evidence that the preferred embodiment of the present invention allow measurements of combined concentrations of NO+NO₂ (NOₓ).

We were able to achieve improvements in the sensor output sensitivity and noise reduction by optimizing lambda sensor operating conditions. Internal sensor heater voltage was set to V=8V, Outside furnace temperature was set at T=335° C. The conditioning treatment involved DC pulses with the amplitude of +/−2.5 Volts and with the duration of 2 sec. Pulses were separated by pauses (with the duration of 5 sec).

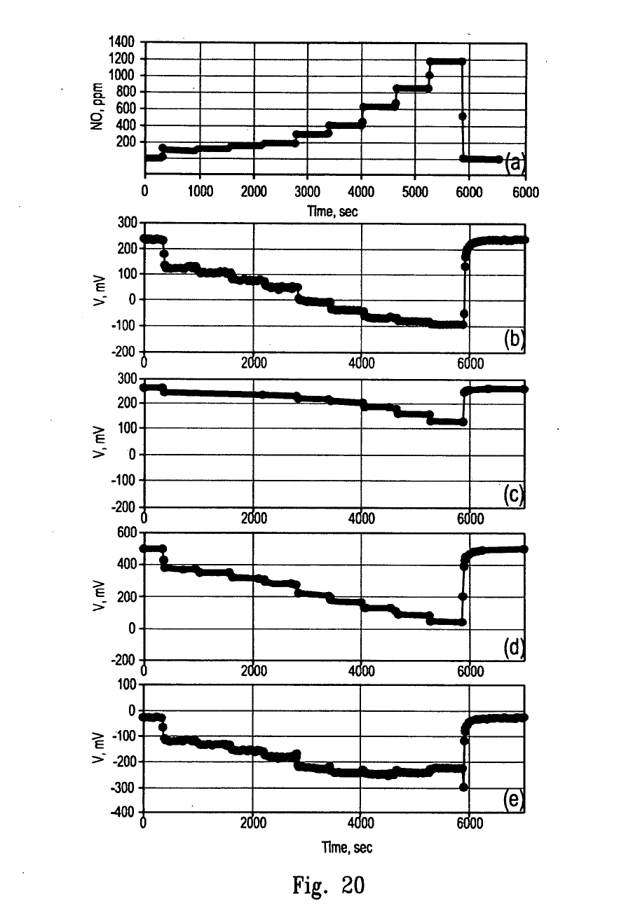

FIG. 20 shows lambda sensor response to step changes of NO from 0 to 1200 ppm while subjected to the conditioning treatment. Sensor response is strong and shows no hysteresis. By combining sensor responses after positive and negative voltage pulses overall sensor sensitivity can be improved from ˜350 mV per 1200 ppm NO to ˜500 mV per 1200 ppm NO.

Data shown in FIG. 20 were used to establish calibration curve, which can be described by equation (6) with only two fitting parameters.

NO(ppm)=exp(a+b*(mV)) (6)

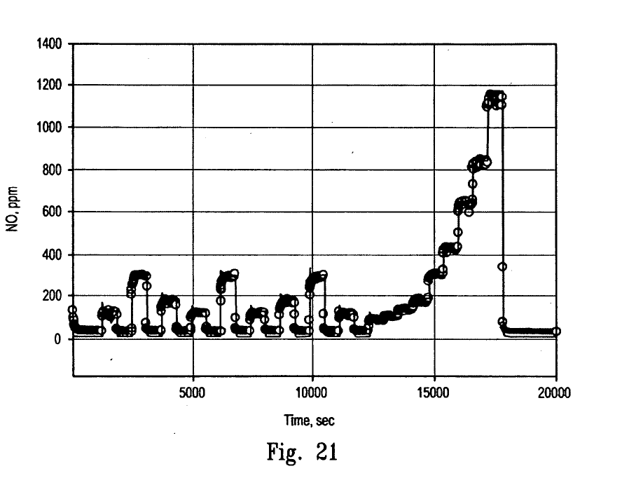

FIG. 21 shows a comparison between measured NO concentration while using conditioning treatment under preferred embodiment of the current invention and the results measured with an extractive benchtop analyzer (Horiba 510 series). Data indicate a very close match with the results of a traditional laboratory instrument.

### Example 2

### Measurements of NO with an Industrial Zirconia Oxygen Sensor for Boiler Combustion Control

A distinctive feature of an automotive lambda sensor is a protective porous layer deposited on the measurement electrode (See J-H-Lee, “Review on Zirconia air-fuel ratio sensors for automotive applications” Journal of Materials Science, v. 38, pp 4247-4257, 2003).

To test conditioning treatment on a different type of a mixed potential sensor we used a commercial zirconia oxygen analyzer used for boiler combustion control (See U.S. Pat. No. 3,928,161). This sensor does not have a protective coating on the measurement Pt electrode.

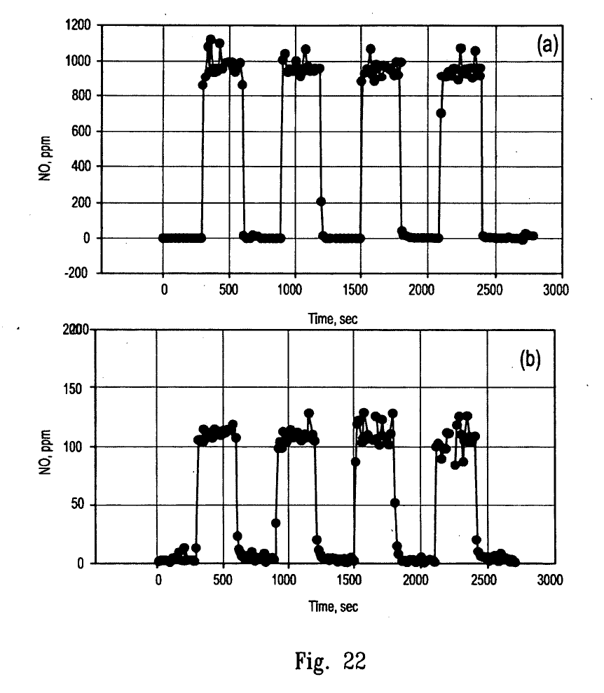

Test conditions were as follows: Sensor operating temperature T=450C, DC pulse amplitude V=+/−2.5V, pulse duration=2 sec, pause duration=5 sec, O₂=2%, NO pulses 0-1000 ppm and 0-100 ppm. FIG. 22 shows results of the NO concentration measurements in the preferred embodiment of the present invention. Under conditioning treatment sensor exhibit fast response and recovery, no drift and good repeatability.

### Example 3

### Measurements of Carbon Monoxide with an Automotive Lambda Sensor

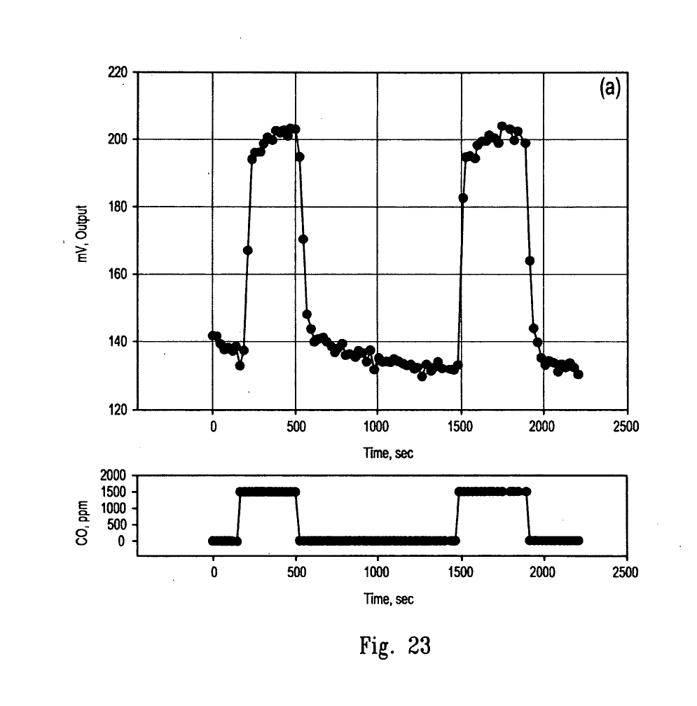

Sensitivity to different gases in the exhaust gas mixture can be varied in the preferred embodiment of the present invention by varying amplitude of the conditioning voltage pulses. FIG. 23 shows a lambda sensor response to 1500 ppm CO (at 2% O₂) while subjecting sensor to conditioning treatment with the amplitude of conditioning voltage pulses=+/−1 Volts. Sensor sensitivity to CO has significantly improved as compared with the conditioning treatment with the voltage amplitude of +/−2.5 Volts.

### Example 4

### Measurements of Carbon Monoxide with an Industrial Zirconia Oxygen Sensor for Boiler Combustion Control

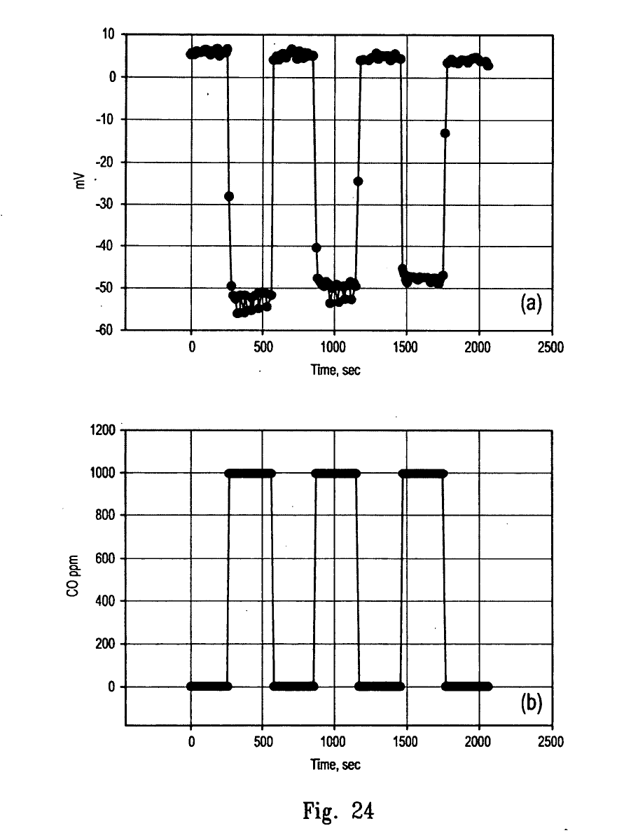

By varying sensor temperature and parameters of the conditioning treatment, sensitivity of an industrial zirconia oxygen sensor for boiler combustion control to CO concentration can be significantly improved. FIG. 24 shows sensor response to pulses of CO from 0-1000 ppm at 2% O₂ and operating temperature T=500° C. while subjected to conditioning treatment with pulse amplitude of V=+/−3V, pulse duration=2 sec, pause duration=5 sec.

### Example 5

### Measurements of Carbon Monoxide with Mixed Potential Sensor Based on Gold Composite Electrodes

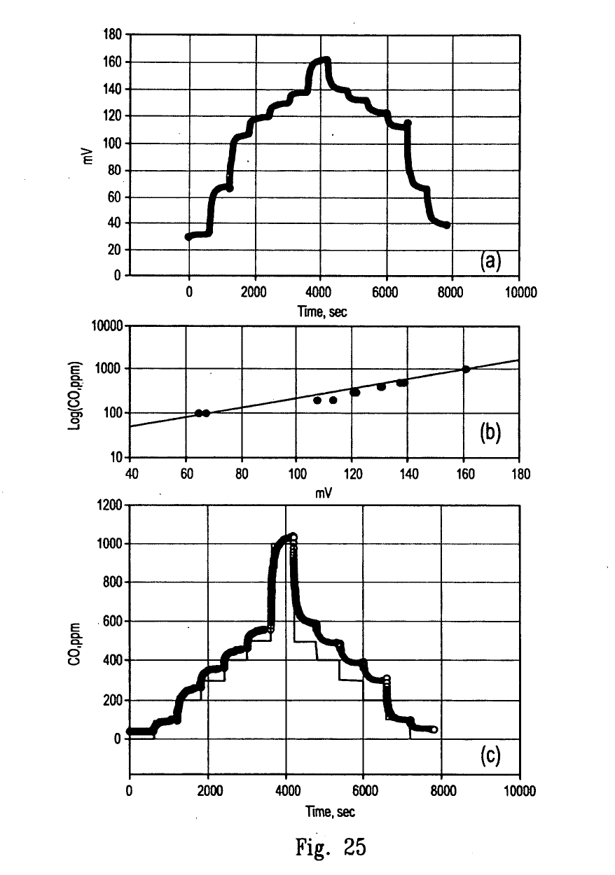

It is known in a prior art that a sensor equipped with two electrodes exhibiting different catalytic activity to CO oxidation will demonstrate mixed potential response. To test the conditioning treatment in the preferred embodiment of the present invention we selected a zirconia based sensor equipped with a sensing Pt and composite Au-20 wt % Ga₂O₃ electrodes in the configuration shown in FIG. 3 with both electrodes exposed to the analyzed gas. (see Zosel, J. et al. “Response behavior of perovskites and Au/oxide composites as HC-electrodes in different combustibles” (2004) Solid State Ionics, v. 175, Issue 1-4, pp. 531-533) Sensor was tested at T=600° C., O₂=5% with CO concentration varied from 0 to 1000 ppm. FIG. 25 shows sensor response to variation in CO concentration as known in the prior art without conditioning treatment. Sensor response is sluggish and there is an apparent strong hysteresis. FIG. 25 (c) shows significant deviation (˜100 ppm) between applied and measured (based on the calibration curve) CO concentrations.

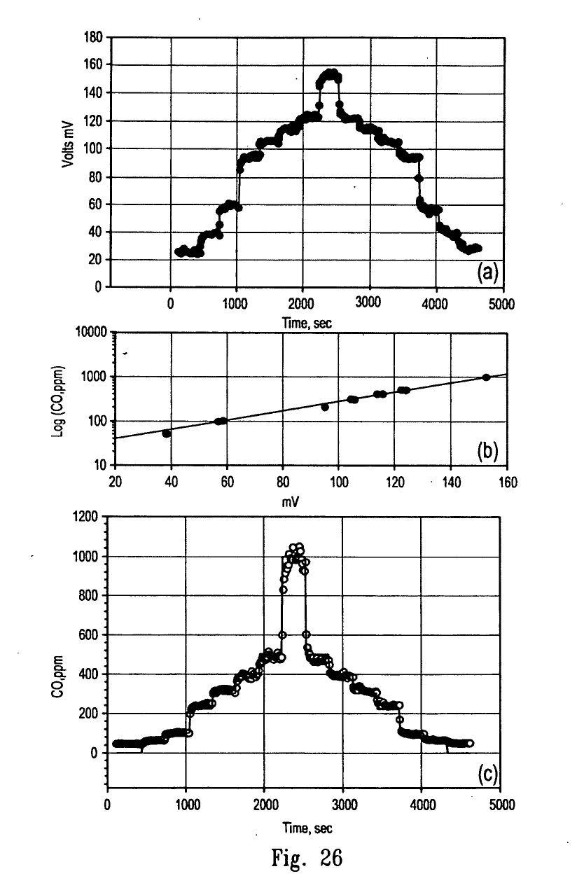

FIG. 26 shows that conditioning treatment in the preferred embodiment of the current invention considerably improves sensor performance by improving speed of the sensor response from −250 sec without conditioning treatment to ˜25 seconds with conditioning treatment.

Conditioning treatment also reduces hysteresis and improves accuracy of measurements. Maximum error without conditioning treatment is ˜100 ppm while with the conditioning treatment is <20 ppm.

An alternative method of CO/NOx detection can be based on charging the capacitance associated with the sensor electrodes by applying current pulses and measuring the discharge current during the pauses following the current pulses of opposite polarity.

A similar setup as shown in FIG. 5 can be used. External power supply will be replaced with a current source and data acquisition system will be measuring discharge current during the pauses separating current charge pulses.

Advantages of our proposed method of sensor conditioning as demonstrated in examples 1 through 5 can be summarized as following

1. Positive and negative pulses have equivalent amplitude and are not causing net polarization of sensor electrodes.
2. It is improving sensor stability by refreshing active reaction sites via fresh supply of O²⁻ ions in each cycle preventing an accumulation of charge from redox reactions. It can also potentially prevent the poisonous effects of minute constituents of the exhaust stream (SO₂/SO₃ for example), which normally interfere and mask the response to analyzed CO/NO gases.
3. Applied voltage amplitude and pulse duration can be selected to improve sensitivity to a particular analyzed gas (CO or NOₓ). Reactions 2 and 3 described above can be accelerated by applying positive or negative potential.
4. Proposed sensor conditioning can be applied to traditional zirconia O₂ sensor with one electrode exposed to analyzed gas and reference electrode exposed to air. It can be also applied to sensors with two electrodes exposed to the analyzed gas, which generate mixed potential response due to different catalytic activity of two electrodes.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. A method of mixed potential sensor electrode conditioning for improving signal output stability and differentiation between responses to different gases, comprising:
(a) applying a voltage pulse of positive polarity and fixed amplitude and duration between at least two sensor electrodes;
(b) applying a pause for a fixed duration when a charging power supply is disconnected from a sensor on said electrodes, and a sensor discharge is recorded;
(c) applying a next voltage pulse of opposite polarity and fixed, equivalent amplitude for the same duration as the first pulse between said sensor electrodes;
(d) applying a next pause with a fixed duration equal to the previous pause when said, charging power supply is disconnected from said sensor, and said sensor discharge is recorded; and,
(e) repeating steps (a)-(d).

2. An improved method of measuring gas concentration in combustion exhaust utilizing a sensor in a mixed potential response mode, said sensor has at least two electrodes separated by an electrolyte, said method comprises the steps:
(a) charging a sensor by applying at least one sequence of voltage pulses with positive and negative polarity and fixed and equal amplitude and duration between two electrodes;
(b) separating each of said voltage pulses by pauses by means of disconnecting said electrodes from a power supply for a fixed duration;
(c) measuring sensor output voltage during each of said the pauses following each of said positive and said negative voltage pulses;
(d) approximating sensor discharge voltage by means of equation Vᵣ=Vₒ+S·Log(t), wherein S and Vₒ are slopes and a constant calculated from a linear regression of an initial part of a discharge curve in semi-logarithmic coordinates V Log(t), and t is a time elapsed during said pause;
(e) determining extrapolated discharge sensor voltage values at a fixed time to elapsed during said pause following positive Vᵣ₀⁺ and negative Vᵣ₀⁻ voltage pulses, wherein
Vᵣ₀⁺=(Vₒ)⁺+S⁺·Log(t₀), and
Vᵣ₀⁻=(Vₒ)⁻+S⁻·Log(t₀);
(f) relating extrapolated values Vᵣ₀ to an analyzed gas concentration by establishing said calibration curve as a dependence between known analyzed gas concentration C and one of said sensor responses Vᵣ₀⁺, Vᵣ₀⁻, Vᵣ₀⁺+Vᵣₒ⁻, or Vᵣ₀⁺−Vᵣ₀⁻, wherein C=F(Vᵣ₀); and,
(g) calculating said analyzed gas concentration in an analyzed process by using said sensor response Vᵣ₀ and said established calibration curve.

3. The method of claim 2, wherein said fixed positive and negative pulse duration is selected in a range of 0.001-2 seconds.

4. The method of claim 2, wherein said fixed pause duration following the positive and negative pulses is selected in a range of 0.001-10 seconds.

5. The method of claim 2, wherein said fixed pulse amplitude is selected from a range of +/−0.01 to +/−3 Volts.

6. The method of claim 2, wherein said sensor is a zirconia based oxygen sensor or any potentiometric sensor in a mixed potential response mode.

7. The method of claim 2, wherein a gas is selected from a group comprising: NOₓ, NO, NO₂, CO, unburned hydrocarbons, and other gases present in combustion exhaust.

8. A method of measuring mixed gas by conditioning an output signal from a sensor, said method consisting of the steps:
a. Applying voltage pulses (DC, saw tooth or any other shape) of opposite polarity and approximately equivalent amplitude between the sensor electrodes by connecting sensor electrodes to a charging power supply;
b. Separating said pulses by pauses by a technique such as but not limited to disconnecting the charging power supply from the sensor;
c. Extracting information regarding concentration of analyzed gases by recording sensor discharge voltage decay during pause immediately following voltage pulse.

9. The method of claim 8, wherein said sensor discharge information is recorded by the steps:
a. calculate sensor response (Vr) to the analyzed gas as a Voltage at a specific time elapsed during the pause (to)
Vr=Vo+S*Log(to)
where S and Vo are the slope and the constant calculated from a linear regression of the initial part of the voltage decay curve in the semi-logarithmic coordinates (V˜Log(t));
b. Establish a calibration curve as a dependence between known analyzed gas concentration (C) and sensor response Vr.
C=F(Vr);
c. Calculation of the analyzed gas concentration in the analyzed process by using sensor response (Vr) and the established calibration curve.

10. The method of claim 8, wherein said mixed gases are selected from the group comprising but not limited to: NOx, NO, NO2, CO, CO2, unburned hydrocarbons; and other gases which are present in combustion exhaust.

11. The method of claim 8, wherein said sensor is selected from the group comprising but not limited to: potentiometric zirconia oxygen sensors equipped with platinum electrodes; Lambda sensors; and mixed-potential gas sensors.

12. A method of mixed potential sensor electrode conditioning, said method comprising the steps:
(a) applying a current pulse of positive polarity and fixed amplitude and duration between at least two sensor electrodes;
(b) applying a pause for a fixed duration when a charging power supply is disconnected from a sensor on said electrodes, and a sensor discharge is recorded;
(c) applying a next current pulse of opposite polarity and fixed, equivalent amplitude and the same duration as the first pulse between said at least two sensor electrodes;
(d) applying a next pause with a fixed duration equal to the previous pause when said charging power supply is disconnected from said sensor, and said sensor discharge current is recorded; and,
(e) repeating steps (a)-(d).
